(19) United States
(12) Patent Application Publication
(10) Pub. No.: US 2006/0209457 A1
(43) Pub. Date: Sep. 21, 2006

(54) SPINDLE MOTOR

(75) Inventor: Junichi Kamijo, Shizuoka-shi, Shizuoka-ken (JP)

Correspondence Address: CONNOLLY BOVE LODGE & HUTZ LLP, SUITE 800, 1990 M STREET NW, WASHINGTON, DC, 20036-3425, US

(73) Assignee: VICTOR COMPANY OF JAPAN, LIMITED, Kanagawa-ku (JP)

(21) Appl. No.: 11/307,820

(22) Filed: Feb. 24, 2006

(30) Foreign Application Priority Data
Mar. 16, 2005 (JP) 2005-074650

(51) Int. Cl. G11B 17/02

(52) U.S. Cl. 360/99.08

(57) ABSTRACT

A spindle motor (100) is composed of a rotor section (R) having a chucking magnet (3) for sucking in a disc hub (11) made from a magnetic material, wherein the rotor section (R) is rotatably maintained with respect to a stator section (S). The chucking magnet (3) is further composed of a first magnet (3a) in almost an arc shape having a first width W1 in a radial direction and a second magnet (3b) in almost an arc shape having a second width W2 in a radial direction, wherein the first magnet (3a) is magnetized in a plurality of magnetic poles at a first angular interval P1 in a circumferential direction and the second magnet (3b) is magnetized in a plurality of magnetic poles at a second angular interval P2 in a circumferential direction, and wherein a relationship between each width and each angular interval satisfies an equation W1/W2=P1/P2.

### BACKGROUND OF THE INVENTION

1. Field of the Invention

The present invention relates to a spindle motor for driving a disc such as a flexible disc, particularly, relates to a spindle motor, which enables to stably maintain a flexible disc without slanting the flexible disc.

2. Description of the Related Art

A spindle motor to be installed in a disc drive for driving a flexible disc, which is one of information recording discs, is constituted by a stator section including a motor base, a shaft being rotatably supported by a bearing that is fixed on the motor base in standing up, and a rotor section that is fixed to the shaft.

A flexible disc is provided with a disc substrate that is coated with a hard magnetic material and a disc hub in almost a cup shape made from stainless steel that is a soft magnetic material.

As the disc hub of a flexible disc is magnetically sucked in by a chucking magnet provided on the rotor section of a spindle motor, the flexible disc is maintained on the rotor section of the spindle motor.

The chucking magnet for sucking in a disc hub is formed in almost an annular shape and magnetized in a plurality of magnetic poles in the circumferential direction. An example of such a configuration of maintaining a flexible disc was disclosed in the Japanese publication of unexamined patent applications Nos. 5-144168/1993 and 6-311680/1994.

Further, there existed another spindle motor, in which a chucking magnet was constituted by a plurality of magnets in an arc shape not by a single annular magnet.

As mentioned above, a flexible disc (hereinafter referred to as FD) is maintained on a rotor yoke of the rotor section of the spindle motor. In order to maintain the FD on the rotor yoke stably, it is necessary for a surface of the rotor yoke to be flat without slanting, wherein the FD is placed on the surface of the rotor yoke and loaded thereon.

Further, it is also necessary for suction power caused by magnetic force of the chucking magnet, which sucks a disc hub of the FD, to be balanced in the rotative direction with centering the shaft of the spindle motor.

If the above-mentioned requirements are not satisfied, the disc hub is not stably maintained on the surface of the rotor yoke and resulting in slanting the FD. Consequently, the FD does not accurately engage with either the shaft or a driving pin that is provided on the rotor section of the spindle motor so as to adjust a rotational position of the FD.

In this connection, positioning a center of the FD can not be accurately performed and repeatability of the motor rotation is deteriorated.

Accordingly, an error possibly occurs when recording or reproducing the FD.

As mentioned above, there existed a spindle motor of which chucking magnet was constituted by a plurality of magnets. Such a spindle motor was constituted in that a chucking magnet was composed of two individual portions, a first magnet and a second magnet. In such a spindle motor, the first and second magnets were constituted in that a width in the radial direction of a suction surface of the first magnet was narrower than that of a suction surface of the second magnet.

Further, each magnet was magnetized at equiangular intervals with centering the shaft.

Since suction power of each magnet for sucking in the disc hub is in proportion to magnetic force of each magnet, suction power of the first magnet having the narrower suction surface is weaker than that of the second magnet having the wider suction surface. In this connection, suction power is unbalanced in the circumferential direction of the shaft.

Accordingly, in some cases, an FD happened to be loaded on the rotor yoke with being slanted.

Such a phenomenon of unbalanced suction power possibly occurs even in the spindle motors that were disclosed in the Japanese publication of unexamined patent applications No. 5-144168/1993 and 6-311680/1994 of which chucking magnet was constituted by a single annular magnet and not divided into a plurality of magnets in an arc shape.

In order to solve unbalanced suction power, the Japanese publication of unexamined patent applications No. 6-311680/1994 disclosed that a magnetic pole disposed on the opposite side of the driving pin was decreased in magnetic force by applying a reverse magnetic field, and that magnetic flux density of the outer circumferential section of the chucking magnet was reduced to almost zero by applying a reverse magnetic field. However, decreasing magnetic force by applying a reverse magnetic field is hardly realized accurately at a fixed level due to original characteristic variations of the magnet.

Further, in case of canceling magnetic flux density of the outer circumferential section of the chucking magnet, total magnetic flux of the chucking magnet is extremely reduced, and resulting in weakening suction power of the chucking magnet for sucking in the disc hub. On the contrary, it possibly occurs that an FD is hardly maintained stably.

In other words, since a shape of the chucking magnet is determined in accordance with arrangements of other members constituting the spindle motor such as driving pin, a width of the suction surface of the chucking magnet is never uniformed in the circumferential direction on the basis of designing.

Accordingly, suction power becomes uneven in the circumferential direction, and resulting in a problem such that a disc hub of an FD is slanted when being sucked in or the FD is not stably maintained.

### SUMMARY OF THE INVENTION

Accordingly, in consideration of the above-mentioned problems of the prior arts, an object of the present invention is to provide a spindle motor, which enables to stably maintain a flexible disc without being slanted.

In order to achieve the above object, the present invention provides, according to an aspect thereof, a spindle motor comprising a rotor section having a chucking magnet for sucking in a disc hub made from a magnetic material, wherein the rotor section is rotatably maintained with respect to a stator section, the chucking magnet further comprising: a first magnet in almost an arc shape having a first width W1 in a radial direction; and a second magnet in almost an arc shape having a second width W2 in a radial direction, wherein the first magnet is magnetized in a plurality of magnetic poles at a first angular interval P1 in a circumferential direction and the second magnet is magnetized in a plurality of magnetic poles at a second angular interval P2 in a circumferential direction, and wherein a relationship between each width and each angular interval satisfies an equation W1/W2=P1/P2.

Other object and further features of the present invention will be apparent from the following detailed description when read in conjunction with the accompanying drawings.

### BRIEF DESCRIPTION OF THE DRAWINGS

FIG. 1 is a plan view of a spindle motor according to an embodiment of the present invention.

FIG. 2 is a fragmentary cross sectional view of the spindle motor taken along line L-L of FIG. 1.

FIG. 3(a) is a plan view of a chucking magnet according to the embodiment of the present invention showing an arrangement of two magnets to be die-cut from a sheet metal.

FIG. 3(b) is a plan view of the chucking magnet according to the embodiment of the present invention showing an actual disposition of the two magnets to be used in the spindle motor shown in FIG. 1.

### DETAILED DESCRIPTION OF THE PREFERRED EMBODIMENTS

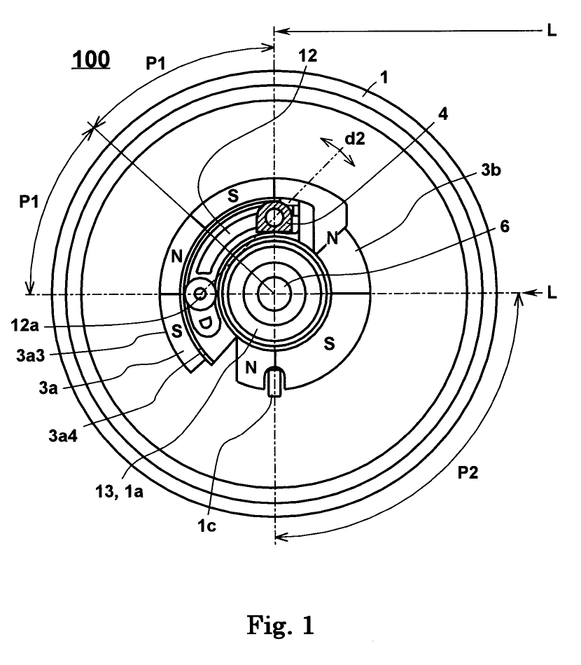

FIG. 1 is a plan view of a spindle motor according to an embodiment of the present invention.

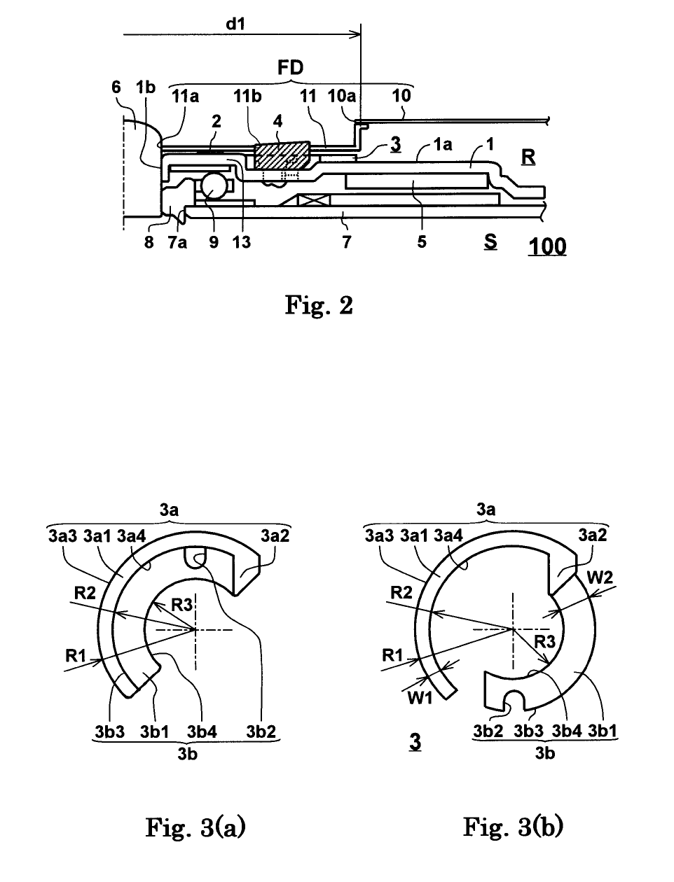

FIG. 2 is a fragmentary cross sectional view of the spindle motor shown in FIG. 1, wherein a flexible disc is sucked in and loaded on the spindle motor.

In FIGS. 1 and 2, a spindle motor 100 is composed of a rotor section “R” and a stator section “S”. The stator section “S” is further composed of a motor base 7 and a sintered oil impregnation bearing 8, which is made from a copper or iron system material and force fitted into a hole 7a of the motor base 7. The rotor section “R” is further composed of a rotor yoke 1, a resin sheet 2, a chucking magnet 3, a driving pin 4, a main magnet 5 for driving the rotor section “R” and a shaft 6. The resin sheet 2 is adhered on a surface 1 a of the rotor yoke 1 in a raised portion 13 on which a flexible disc FD (hereinafter simply referred to as FD) is placed so as to be loaded, wherein the FD is constituted by a disc substrate 10 and a disc hub 11. The chucking magnet 3 for sucking in the FD is magnetized in a plurality of magnetic poles. The driving pin 4 is utilized for adjusting a rotational position of the FD. The main magnet 5 is magnetized in a plurality of magnetic poles at equiangular intervals. The shaft 6 is made from a stainless steel system material and force fitted into a center hole 1b of the rotor yoke 1.

Further, the shaft 6 is engaged with the sintered oil impregnation bearing 8

Furthermore, the rotor section “R” is rotatably supported in a thrust direction and a radial direction with respect to the stator section “S” through the sintered oil impregnation bearing 8 and a plurality of steel balls 9, which is sandwiched between the rotor section “R” and the stator section “R”.

With referring to FIGS. 3(a) and 3(b), the chucking magnet 3 is detailed next.

FIG. 3(a) is a plan view of the chucking magnet 3 showing an arrangement of two magnets when being die-cut from a sheet metal.

FIG. 3(b) is a plan view of the chucking magnet 3 when used in the spindle motor 100 shown in FIG. 1.

As shown in FIGS. 3(a) and 3(b), the chucking magnet 3 is further composed of a first magnet 3a in almost an arc shape and a second magnet 3b in almost an arc shape. The first magnet 3a is formed with an outer circumference 3a3 having a first radius R1 and an inner circumference 3a4 having a second radius R2. The second magnet 3b is formed with an outer circumference 3b3 having the second radius R2 and an inner circumference 3b4 having a third radius R3.

Further, almost all circumference along the inner circumference 3a4 of the first magnet 3a is formed with having the second radius R2 so as not to interfere with the driving pin 4 to be detailed. A part of the first magnet 3a that does not interfere with the driving pin 4 is protruded inward or toward a center of the arc and formed as a protruded section 3a2.

On the contrary, the outer circumference 3b3 of the second magnet 3b is provided with a cutout section 3b2 for positioning, which is provided for engaging with a protrusion 1c formed on the rotor yoke 1 as shown in FIG. 1, wherein the protrusion 1c is provided for positioning the chucking magnet 3 in place.

The first and second magnets 3a and 3b are arranged such that the second radius R2 is common to them as shown in FIG. 3(a), and die-cut from a sheet metal. Then the second magnet 3b is reversed and combined with the first magnet 3a as shown in FIG. 3(b), and resulting in forming the chucking magnet 3.

The first and second magnets 3a and 3b are mounted on the rotor yoke 1, and then magnetized by a magnetizing yoke in a plurality of magnetic poles at prescribed angular intervals.

On the other hand, the FD, as roughly mentioned-above, is composed of the disc substrate 10 in an annular shape that is coated with a hard magnetic material and the disc hub 11 in almost a cup shape, which is made from stainless steel that is a soft magnetic material and adhered along a center hole 10a of the disc substrate 10.

The disc hub 11 has a center hole 11 a and a hole 11b, wherein the hole 11b is bored in a position away from the center of the disc hub 11 for engaging with the driving pin 4.

When the FD is inserted into a disc drive installed with the spindle motor 100, the FD is transported by a loading mechanism not shown to a position at where the center of the FD approximately coincides with the center of the shaft 6. Then the center hole 11a engages with the shaft 6 and the hole 11b engages with the driving pin 4.

Further, the disc hub 11 is sucked in by magnetic force of the chucking magnet 3 and pressed against the resin sheet 2.

Accordingly, the FD is stably maintained on the rotor section “R” and driven to rotate, and then the FD results in enabling to be recorded or reproduced by the disc drive.

In FIGS. 1 and 2, as mentioned above, the shaft 6 is force fitted into the center hole 1b of the rotor yoke 1 and the driving pin 4 is disposed in a position away from the center of the rotor yoke 1.

Further, the driving pin 4 is sustained so as to be movable, wherein the driving pin 4 enables to swing in an arrow d2 direction within a prescribed angular interval with respect to the rotor yoke 1 by means of a driving pin arm 12 with centering on a fulcrum 12a of the driving pin arm 12.

Accordingly, the movable driving pin 4 enables to engage with the hole 11b of an FD, and resulting in centering of the FD.

In the above-mentioned configuration of the spindle motor 100, the chucking magnet 3 is formed in a shape so as not to interfere with the driving pin 4 and disposed in place.

In other words, the first magnet 3a is formed in a shape such that the second radius R2 of the inner circumference 3a4 is made larger so as not to interfere with the driving pin 4.

Further, in case a contour of the chucking magnet 3 is larger than a draw diameter d1 shown in FIG. 2 of the disc hub 11, that is, an area of the disc hub 11 protruded toward the rotor yoke 1, a section of the chucking magnet 3 protruding from the area having the draw diameter d1 of the disc hub 11 is not responsible for sucking in the disc hub 11. In this connection, the first radius R1 of the outer circumference 3a3 of the fist magnet 3a is made slightly smaller than a draw radius, that is, one half of the draw diameter d1.

Further, the first magnet 3a, which is disposed diagonally left upper portion in FIG. 1, is composed of a suction surface 3a1 in almost a fan shape having a first width W1. The second radius R2 of the inner circumference 3a4 of the first magnet 3a is relatively large although the first radius R1 of the outer circumference 3a3 is relatively small, so that the first width W1 is relatively narrow. In other words, the first magnet 3a is composed of the suction surface 3a1 having a narrow width W1.

On the other hand, in case of the second magnet 3b, which is disposed diagonally right lower portion in FIG. 1, a radius of the outer circumference 3b3 is made to be the second radius R2 so as to eliminate wasteful material consumption when manufacturing the chucking magnet 3. As shown in FIG. 3(a), the first and second magnets 3a and 3b are arrange such that the inner circumference 3a4 of the first magnet 3a coincides with the outer circumference 3b3 of the second magnet 3b and die-cut from a sheet metal.

Further, the second magnet 3b is reversed and combined with the first magnet 3a as shown in FIG. 3(b) when affixing the first and second magnets 3a and 3b on the rotor yoke 1 as the chucking magnet 3.

Furthermore, with respect to the second magnet 3b, the outer circumference 3b3 has the second radius R2 that is common to the inner circumference 3a4 of the first magnet 3a. An inner diameter of the inner circumference 3b4 is made to be equal to an outer diameter of the raised portion 13 of the rotor yoke 1 so as to ease positioning of the second magnet 3b when affixing on the rotor yoke 1, wherein the raised portion 13 is provided for loading an FD as mentioned above.

In addition thereto, the second magnet 3b is formed in almost a fan shape, wherein a suction surface 3b1 has a second width W2 that is wider than the first width W1.

More specifically, the first magnet 3a is formed in that the first radius R1 of the outer circumference 3a3 is 12.20 mm, the second radius R2 of the inner circumference 3a4 is 10.45 mm and the first width W1 of the suction surface 3a1 is 1.75 mm.

On the other hand, the second magnet 3b is formed in that the second radius R2 of the outer circumference 3b3 is 10.45 mm, the third radius R3 of the inner circumference 3b4 is 7.00 mm and the second width W2 of the suction surface 3b1 is 3.45 mm.

In addition thereto, the first magnet 3a is magnetized at an angular interval P1 of 45 degrees with respect to the shaft 6 and magnetized in the N-pole and the S-pole alternately.

On the other hand, the second magnet 3b is magnetized at angular interval P2 of 90 degrees with respect to the shaft 6 and magnetized in the N-pole and the S-pole alternately. In other words, the angular interval P2 of the second magnet 3b is twice the angular interval P1 of the first magnet 3a.

Accordingly, relationship between the width and the angular interval of each magnet are defined as follows:
W1/W2=P1/P2 (Equation 1)

When magnetizing the chucking magnet 3, an electric wire is wound around a boundary between the magnetic poles in a magnetizing yoke, and then magnetization is conducted by instantaneously flowing a large amount of electric current through the electric wire.

Accordingly, in case of the second magnet 3b having the wider angular interval P2 of magnetization, sufficient magnetic flux is generated in the neighborhood of the winding of the electric wire, that is, neighborhood of the boundary between the magnetic poles.

In this connection, suction power with respect to the disc hub 11 is in proportion to a total amount of magnetic flux. Therefore, the total amount of magnetic flux or suction power is inverse proportion to an angular interval of magnetized poles as long as a width and a material of each magnet are the same.

As mentioned above, there exists a specific relationship between a total amount of magnetic flux and angular intervals of magnetized poles, so that description is given to a total amount of magnetic flux.

In case of the second magnet 3b, the second width W2 is almost twice the first width W1 of the first magnet 3a and the angular interval P2 is twice the angular interval P1 of the first magnet 3a, and resulting in canceling each other. Therefore, a total amount of magnetic flux of the second magnet 3b becomes equal to that of the first magnet 3a. In other words, suction power acting on the disc hub 11 of the first magnets 3a becomes approximately the same as that of the second magnet 3b, so that suction power of the chucking magnet 3 sucking in the disc hub 11 is evenly distributed along the circumference of the chucking magnet 3.

Accordingly, an FD enables to be stably maintained on the spindle motor 100 without being slanted.

According to the above-mentioned embodiment of the present invention, the suction power that is caused by the magnetic force of the chucking magnet 3 and acts on the disc hub 11 is balanced in the circumferential direction of the shaft 6. Therefore, the disc hub 11 is sucked in and stably maintained on the raised portion 13 of the rotor yoke 1 without being slanted, and results in excellently engaging with the shaft 6 and the driving pin 4.

Accordingly, positioning a center of an FD enables to be accurately conducted and repeatability of the motor rotation becomes excellent, so that an error never occurs when recording or reproducing the FD.

Further, magnetic flux density of the outer circumferential section of the chucking magnet 3 is not cancelled, so that stable magnetic force enables to be always obtained by magnetization although the first and second magnets 3a and 3b vary in characteristics.

Furthermore, partially canceling magnetic flux density is never conducted, so that a total amount of magnetic flux of the chucking magnet 3 is never reduced extremely. Consequently, the disc hub 11 enables to be sucked in strongly, and the FD results in being maintained more stably without fail.

More, the shape of the chacking magnet 3 is not limited to be a specific one, or it is not necessary for the driving pin 4 to be miniaturized in particular. Consequently, sufficient mechanical strength of the spindle motor 100 enables to be ensured even by using less expensive materials.

Moreover, the driving pin 4 enables to move ideally, so that chucking-miss never occurs.

While the invention has been described above with reference to a specific embodiment thereof, it is apparent that many changes, modification and variations in materials and the arrangement of equipment and devices can be made without departing from the invention concept disclosed herein. For instance, in the above-mentioned embodiment of the present invention, the ratio of the angular interval P2 of the second magnet 3b to the angular interval P1 of the first magnet 3a is two, that is, P2/P1=2 with respect to the ratio of the width in the radial direction of the first and second magnets 3a and 3b, that is, W2/W1=2. However, as shown in the above-mentioned (Equation 1), any combinations of ratios are applicable as long as two magnets are magnetized at respective angular intervals in proportion to each width in a radial direction of the magnets. In case of “W2/W1=1.5”, for example, a combination (P1, P2) of angular intervals for magnetization enables to be designated to (30°, 45°) or (10°, 15°) by way of example.

It shall be understood that a chucking magnet is not limited to a plurality of magnets. A single annular magnet is also applicable for a chucking magnet.

Further, such a magnet that is partially formed with a cutout is also applicable for a chucking magnet as long as a relationship between a width in a radial direction and angular intervals for magnetization satisfy the (Equation 1) generally.

Furthermore, it is preferable that making angular intervals narrower enables to finely cope with various widths.

In addition thereto, in case a magnet has a plurality of widths in a circumferential direction, the magnet shall be magnetized at a plurality of angular intervals in response to a relative ratio of respective widths.

It should be understood that many modifications and adaptations of the invention will become apparent to those skilled in the art and it is intended to encompass such obvious modifications and changes in the scope of the claims appended hereto.

What is claimed as new and desired to be protected by Letters Patent of the United States is:

1. A spindle motor comprising a rotor section having a chucking magnet for sucking in a disc hub made from a magnetic material, wherein the rotor section is rotatably maintained with respect to a stator section, the chucking magnet further comprising:
a first magnet in almost an arc shape having a first width W1 in a radial direction; and
a second magnet in almost an arc shape having a second width W2 in a radial direction,
wherein the first magnet is magnetized in a plurality of magnetic poles at a first angular interval P1 in a circumferential direction and the second magnet is magnetized in a plurality of magnetic poles at a second angular interval P2 in a circumferential direction, and
wherein a relationship between each width and each angular interval satisfies an equation W1/W2=P1/P2.

2. The spindle motor in accordance with claim 1, wherein the first magnet and the second magnet are formed with integrating them.
